(19) United States
(12) Patent Application Publication
(10) Pub. No.: US 2006/0178804 A1
(43) Pub. Date: Aug. 10, 2006

(54) Control device for a motor vehicle and communication method therefor

(76) Inventors: Martin Laichinger, Ebersbach (DE); Alex Aue, Korntal-Muenchingen (DE); Joerg Haecker, Esslingen (DE)

Correspondence Address: KENYON & KENYON LLP, ONE BROADWAY, NEW YORK, NY, 10004, US

(21) Appl. No.: 10/544,114

(22) PCT Filed: Jan. 22, 2004
(86) PCT No.: PCT/DE04/00087

§ 371 Date: Apr. 20, 2006

(30) Foreign Application Priority Data
Jan. 30, 2003 (DE) 103 03 490.0

(51) Int. Cl. F02D 45/00

(52) U.S. Cl. 701/115

(57) ABSTRACT

A motor vehicle control unit, in particular an engine control unit, includes a processor, a first interface for the communication with functional units of the motor vehicle and at least one second interface, which is combined with the processor in a sub-assembly.

### FIELD OF THE INVENTION

The present invention relates to a control unit for controlling functions of a motor vehicle, in particular of the engine of such a motor vehicle, such as the fuel injection, ignition firing point etc., as well as a method for the communication with such a unit. A control unit of this type normally includes a processor, which—controlled by an operating program—receives measured values of operating parameters of the motor vehicle from external functional units and derives commands for the control of this or other functional units from these measured values, which are transmitted to the functional units.

### BACKGROUND OF THE INVENTION

It is known to use a bus, for instance according to the CAN standard, for the communication between the control unit and the various functional units, the control unit and the different functional units being connected to this bus. Such a bus, first of all, must have real-time capability, i.e., it must be able to ensure that a predefined delay time is not exceeded at the same or another functional unit between the acquisition of a measured value by a functional unit and the arrival of a control command generated by the control unit in response to the measured value. Furthermore, to avoid faulty controls, the transmission on the bus must be effectively protected from transmission errors. Such demands restrict the transmission rates that are achievable on the bus.

The fact that considerably higher data quantities must be exchanged with the control unit than will be the case in the subsequent use of the finished control unit in a motor vehicle poses a problem in the development of new control units. These greater data quantities occur because the control unit must communicate not only with the functional units of the engine (or with emulators pretending to be such functional units to the control unit), but additionally also with an external development tool, which allows a developer to closely monitor and influence the processing of the control program by the processor. If the communication with the development tool takes place on the same bus via which the control unit communicates with the functional units, there arises the problem that its transmission capacity is for the most part already depleted by the communication with the functional units, and sufficient capacity for the communication with the development tool is no longer available. A resulting delay in the data transmission to the development tool may give the erroneous impression of a malfunction of the control unit. Although it would be possible to accelerate the transmission to the development tool by assigning it sufficiently high priority on the bus, this in turn would have the result that the demands on the real-time response of the communication between control unit and functional units could not be met in a reliable manner.

One approach for solving this problem is the so-called ETK (emulator key button) technology. This technology uses a special prototype for the development and optimization of a new control unit, which differs from the device produced in series later on in that a multitude of connections is brought out, thereby giving a mounted key button access to the internal data bus of the control unit for reading and writing to a memory of the control unit, etc.

These special prototypes are costly, and the brought out connections place an electrical load on the control unit circuit, so that it is impossible to completely exclude differences in the time behavior and in the electrical characteristics between prototype and serial model.

### SUMMARY OF THE INVENTION

The present invention solves the problem of limited transmission capacity by providing the processor of the control unit with a second interface, which is utilizable exclusively for the communication with a debugger or other external development tools. Via this interface all types of information may be exchanged between the control unit and the development tool without detrimental effect on the time behavior in the communication via the first interface. Since the interface and the processor of the control unit are integrated in one sub-assembly, the lines between the processor and the interface are able to be kept short, so that the capacitive loading of the switching circuits of the control unit by this interface is low.

To be able to transmit great data quantities via the second interface within a short period of time, it is preferably configured for the block transfer of data.

The sub-assembly in which the processor and the second interface are combined may be a printed-circuit board on which the processor and the second interface each constitute one chip or chip sets, but it is preferably a single chip in which the processor and the second interface are integrated.

To minimize the number of connections brought out of such a sub-assembly, it is preferred if the second interface is a serial interface. For instance, this may be an Internet interface, FireWire interface or—especially preferred—a USB interface.

The first interface is preferably also combined with the second interface and the processor in the same sub-assembly. This dispenses with the necessity of bringing a local bus out of the sub-assembly for the communication of the processor with the first interface.

One important advantage of the USB interface is its flexibility and its simultaneous simple and cost-effective design. Complicated administrative functions are located in the host of the USB bus, which is the development tool in the application examined here. The control unit itself requires only simple hardware. However, since the USB is no multi-master bus and all transmission procedures must be triggered by the host, a few special features of the USB will need to be utilized when using a USB interface as second interface for the communication with the development tool.

One important characteristic of the USB interface is its ability to support different transmission modes for the transmission to different endpoints. Block modes, in particular, are available for the transmission of greater data quantities without bus overhead. For instance, different transmission tasks between development tool and control units, such as the measuring of values, transmission of bypass messages to or from the control unit, changing of data values in the memory of the control unit or debugging the code of the control unit, may be assigned individual endpoints. Via these endpoints, specific priorities are able to be assigned in each case and also modes that are adapted to the demands on the transmission tasks with respect to time behavior and capacity. It is advantageous, for example, if bypass messages, which must have high priority, are transmitted in bulk mode or in isochronous transfer mode via an endpoint that is specific to these messages. To process these messages with priority, the development tool may poll their endpoints exclusively until these messages have been processed. Another advantage is the possibility of transmitting high data rates in one transmission direction. For instance, the measured values of a configured measurement are able to be transmitted in isochronous mode at a guaranteed transmission bandwidth, using a packet size of up to 1023 bytes specified by the development tool. This allows the development tool to reserve the required bus bandwidth already when configuring the measurement and thereby ensure that no data are lost by the presence of other bus participants (i.e., by transmission to and from other endpoints).

The motor vehicle control unit according to the present invention may be utilized solely as prototype for the development of a new control unit that is used in series without the second interface. However, since the costs associated with the addition of the second interface are very low, in particular when it is realized on the same semiconductor chip, such a control unit may be installed in a motor vehicle in series production as well.

This has the additional advantage that operating parameters stored in the control unit are able to be read out in a simple manner even in a finished motor vehicle, using the second interface. Functions usually executed by costly tachographs, for instance, may be integrated in a control unit configured according to the present invention in a simple and cost-effective manner.

In addition, a simple possibility for measuring or diagnosing faulty states is provided. A conventional PC, in particular, would be able to communicate directly with the control unit. Further features and advantages of the present invention result from the following description of an exemplary embodiment, with reference to the enclosed figures.

### BRIEF DESCRIPTION OF THE DRAWINGS

FIG. 1 shows a block diagram of a conventional motor vehicle control unit.

FIG. 2 shows a block diagram of a control unit according to the present invention.

### DETAILED DESCRIPTION

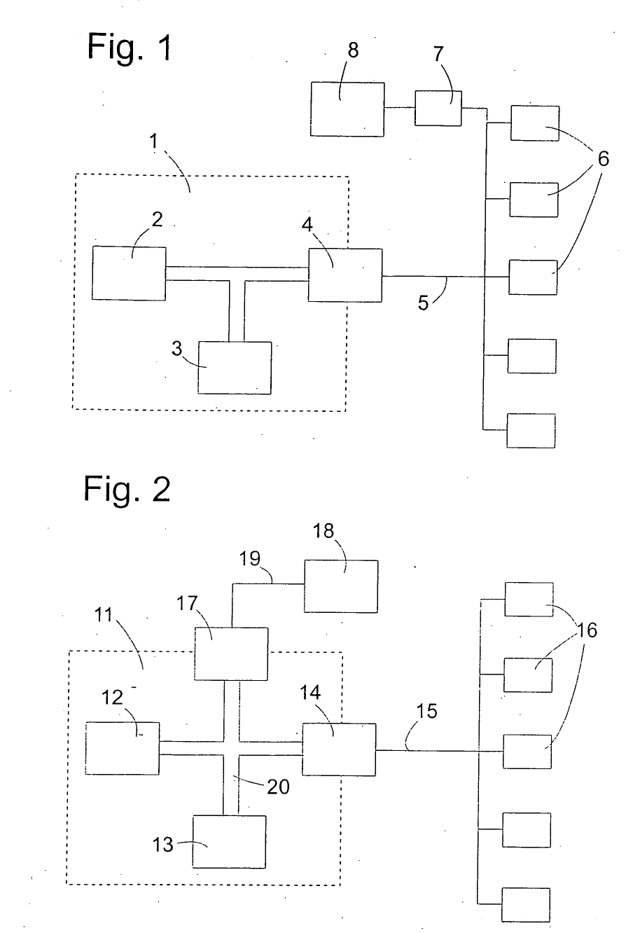

In order to clarify the special features of the control unit according to the present invention, a brief description of a conventional control device will be provided first on the basis of FIG. 1. This control unit 1 includes a microprocessor 2, a storage module 3 and an interface 4 to a bus, especially a CAN bus 5, to which a multitude of functional units 6 of the motor vehicle is connected, which provide measured values of operating parameters of the vehicle to control unit 1 via bus 5 and/or which receive and execute commands from control unit 1. One example for functional units 6 are angle-of-rotation sensors at a crankshaft of the vehicle engine, which provide control unit 1 with a measured value for the angle of rotation of the crankshaft, and spark plugs of the engine, which receive an ignition command derived by control unit 1 from the measured values of the angle-of-rotation sensors. A functional unit 6 may also be a metering system for the fuel injection into the engine, which is triggered by the control unit so as to briefly reduce the injection quantity during a gear change operation of the transmission.

In addition the functional units may perform various other measuring and regulating tasks, which will not be described here in detail.

While control unit 1 is still in the testing and development stage, an interface 7, via which a development tool 18 implemented on an external computer is able to communicate with control unit 1, is connected to CAN bus 5.

In control unit 11 according to the present invention, shown in FIG. 2, a microprocessor 12 is connected to a storage module 13 and two interfaces 14, 17 by means of an internal address data and control bus 20. Since the lines of internal bus 20 are short—if the control unit is made up of a multitude of integrated circuit elements arranged on a printed-circuit board, the line length of the internal bus will generally not exceed approximately 10 cm; if components 12, 13, 14, 17 are integrated on a shared semiconductor substrate, the length of the bus lines is within a range of a few millimeters at most—high clock rates are achievable on internal bus 20, which allow both interfaces 14, 17 to be utilized to the limits of their transmission capacity. The time behavior of the communication of microprocessor 12 with external functional units 16 via serial bus 15 is therefore independent of the scope of the communication between microprocessor 12 and development tool 18 connected to interface 17. Falsification of the real-time behavior of control unit 11 by connected development tool 18 is prevented in this way.

External bus 19, which connects interface 17 with development tool 18, is a serial bus. Although the desire to obtain high transmission capacity between control unit 11 and development tool 18 may tempt one to use a parallel bus, the use of a serial bus is preferred, however, since it makes it possible to work with a smaller number of input/output connections of control unit 11. This aspect is of particular importance in those cases where the entire control unit 11 is to be integrated on a semiconductor substrate.

Any serial bus satisfying the specific requirements with regard to transmission capacity of the individual case may normally be used as external bus, especially an Internet, FireWire or USB bus. Particularly preferred is a USB bus because of the different types of data transfer such a bus routinely supports, any of which is suitable for the various transmission operations arising during the development and optimization process.

Development tool 18 implemented on an external computer is utilized for different applications during the development phase of control unit 11, for instance:
Debugging: Monitoring and controlling the program located in control unit 1 and possibly modifying the commands of the program;
Measuring: Transmitting the contents of individual cells of storage module 3 to development tool 18 at a rate that corresponds to their actualization rate by microprocessor 2, and indicating the physical value that corresponds to the content of the cells by means of the development tool;
Adjusting: Modifying parameters utilized by the control unit in order to examine the effects of the modifications on the behavior of the engine controlled by the control unit;
Bypassing of functions: Since the computing time and the resources in control unit 1 are limited, changes in the programming of the control unit may change its time behavior. To be able to develop functions without initially taking the limited capacity of the control unit into account, the calculation of values of a function in the control unit may be deactivated, the input values of the function being transmitted to the development tool. The development tool calculates the function and later retransmits the function results to the control unit.

These diverse applications are reflected in different demands on the time behavior of the data transmission between development tool 18 and control unit 11.

The transmissions that are not critical with respect to time constitute a first group of transmission processes between development tool 18 and control unit 11. Such transmissions occur mainly in debugging. Among these are, in particular, the transmission of the control program and the output data on the basis of which it is to operate, into storage module 13 at the beginning of the operation of the control unit, or changes in these data during an interruption in the operation of control unit 11. Especially suitable for this type of transmission is the so-called bulk mode of the USB bus. In bulk mode, data packets of maximally 64 bytes are transmitted, and errors in the transmission are detected and remedied. This transmission mode has a lower priority than the other modes supported by the USB bus and may therefore be interrupted if data are to be transmitted in one of the other modes. The short length of the packets in the bulk mode also facilitates the utilization of small gaps between transmissions of higher priority.

To find an error in a control program, it is often necessary to have the program executed in stages, whereby so-called break points are established in the program code at which the control unit is to interrupt the execution of the program. The bulk mode may also be utilized for the transmission of the break points to the control unit and for the acknowledgement to development tool 18 of values of register contents of the processor, parameters etc. that occur over the course of such a stage.

In measuring applications, the temporal development of parameters of the engine, which are monitored by functional units 16 and reported to control unit 11, is to be tracked. Control unit 11 stores these parameter values in stipulated individual storage locations of storage module 13 from where they may be read out and forwarded to development tool 18 via USB bus 19. For the transmission to development tool 18 of the data quantities arising at a high rate, the so-called isochronous mode of the USB bus is preferably utilized. This mode uses data packets of up to 1,023 bytes at a frequency of one packet per milli-second. Since this mode has a very low overhead, large data quantities are able to be transmitted in an efficient manner. The code utilized for the transmission in isochronous mode allows the detection of transmission errors, but not their repair. If development tool detects an error in a packet transmitted in isochronous mode, it may request a retransmission provided sufficient transmission capacity is available; otherwise the particular packet must be discarded.

Bypassing includes the reading of the contents of individual storage cells in control unit 11 by development tool 18 or some other external computer connected to the USB bus—referred to as bypass computer here—and the subsequent replacement of this content by writing into the storage cell a value newly calculated by the development tool or the bypass computer. Such bypassing may be used in the development and optimization of control unit 11, for example in order to simulate to control unit 11 the presence of a functional unit 16, which would provide the values entered in the particular storage location in the actual application environment for which control unit 11 is intended. It may also be used to replace computing processes to be executed by control unit 11 after its development has been completed, but whose programming as yet has not been realized in the development phase of control unit 11 in which the bypassing is utilized.

A value read out from the particular memory location, together with values read out from other memory locations, may be transmitted to development tool 18 or the bypass computer in isochronous mode; if only the value of the particular memory location or a small number of memory locations is to be transmitted to development tool 18 or the bypass computer, the interrupt mode of the USB bus may be used for this purpose. The same interrupt mode is also used for rewriting the new value calculated by development tool 18 or the bypass computer into the particular memory location. In interrupt mode, data packets of maximally 64 bytes are transmitted with 13 byte overhead. Errors in the transmission are detected and remedied.

1.-17. (canceled)

18. A motor vehicle control unit, comprising:
a processor;
a first interface for communicating with a functional unit of a motor vehicle; and
at least one second interface combined with the processor in a sub-assembly.

19. The motor vehicle control unit as recited in claim 18, further comprising:
an engine control unit.

20. The motor vehicle control unit as recited in claim 18, further comprising:
a storage module, wherein:
the at least one second interface accesses the storage module without participation of the processor.

21. The motor vehicle control unit as recited in claim 18, further comprising:
a storage module, wherein:
the at least one second interface accesses a code of the processor in the storage module for a writing purpose.

22. The motor vehicle control unit as recited in claim 18, wherein:
the at least one second interface performs a block transfer of data.

23. The motor vehicle control unit as recited in claim 18, wherein:
the first interface is combined with the processor and the at least one second interface in the sub-assembly.

24. The motor vehicle control unit as recited in claim 18, wherein:
the sub-assembly includes a printed-circuit board.

25. The motor vehicle control unit as recited in claim 18, wherein:
the sub-assembly includes a semiconductor chip.

26. The motor vehicle control unit as recited in claim 18, further comprising:
a storage module for storing operating parameters of the processor, wherein:
the storage module is able to be at least one of written on and read out via the at least one second interface.

27. The motor vehicle control unit as recited in claim 18, wherein:
the at least one second interface includes a serial interface.

28. The motor vehicle control unit as recited in claim 18, wherein:
the at least one second interface includes one of an ethernet and a FireWire interface.

29. The motor vehicle control unit as recited in claim 18, wherein:
the at least one second interface includes a USB interface.

30. The motor vehicle control unit as recited in claim 18, wherein:
the at least one second interface transmits data received from the processor via the first interface in an isochronous mode.

31. The motor vehicle control unit as recited in claim 18, wherein:
the at least one second interface transmits control parameters of the processor in bulk mode.

32. The motor vehicle control unit as recited in claim 18, further comprising:
a storage module, wherein:
the at least one second interface is able to at least one of read and write to individual storage locations of the storage module in an interrupt mode.

33. The motor vehicle control unit as recited in claim 18, wherein:
the at least one second interface is connected to no functional unit of a motor vehicle that is to be controlled.

34. A method for communicating between a motor vehicle control unit and an external host, comprising:
causing the external host to stipulate different USB endpoints and transmission modes for different types of data to be exchanged between the external host and the motor vehicle control unit.

35. The method as recited in claim 34, further comprising:
causing the external host to poll the USB endpoints according to a priority sequence.
